(19) United States
(12) Patent Application Publication
(10) Pub. No.: US 2008/0229372 A1
(43) Pub. Date: Sep. 18, 2008

(54) METHOD AND SYSTEM FOR DELIVERING MEDIA PROGRAMS

(75) Inventor: SCOTT WHITE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/686,299

(22) Filed: Mar. 14, 2007

(51) Int. Cl. H04N 7/173

(52) U.S. Cl. 725/91

(57) ABSTRACT

A method and system for delivering media programs is disclosed. A system that incorporates teachings of the present disclosure may include, for example, a multimedia system having a controller element that receives a transmission request for each of a plurality of media programs, receives a desired viewing time for each of the plurality of media programs, prioritizes an order for transmitting the plurality of media programs according to their respective desired viewing times, and transmits to a presentation device the plurality of media programs according to the prioritized order of transmission for presenting said media programs at a media device coupled to the presentation device. Additional embodiments are disclosed.

### FIELD OF THE DISCLOSURE

The present disclosure relates generally to media program delivery techniques, and more specifically to a method and system for delivering media programs.

### BACKGROUND

Video on demand (VoD) has become a common service that media program distributors offer its subscribers. To deliver good quality digital videos requires large media files, and high-definition digital videos can be typically larger. In current implementations, media file requests are queued for download in the order they are requested. Consequently, when multiple users in a multi-user household utilize VoD services at similar times, downloading a number of large media files over high-speed internet connections can result in a long wait time.

A need therefore arises for a method and system for delivering media programs.

### BRIEF DESCRIPTION OF THE DRAWINGS

FIG. 1 depicts an exemplary embodiment of a communication system;

FIG. 2 depicts an exemplary method operating in the portion of the communication system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method a system for delivering media programs.

In a first embodiment of the present disclosure, a multimedia system can have a controller element that transmits a media program to a presentation device according to a desired viewing time.

In a second embodiment of the present disclosure, a computer-readable storage medium can have computer instruction for receiving media programs from a multimedia system according to the desired viewing time.

In a third embodiment of the present disclosure, a method can involve prioritizing the order of transmission of a plurality of media programs to satisfy in part a plurality of desired view times for said media programs.

In a fourth embodiment of the present disclosure, a multimedia system can have a controller element that receives a transmission request for each of a plurality of media programs, receives a desired viewing time for each of the plurality of media programs, prioritizes an order for transmitting the plurality of media programs according to their respective desired viewing times, and transmits to a presentation device the plurality of media programs according to the prioritized order of transmission for presenting said media programs at a media device coupled to the presentation device.

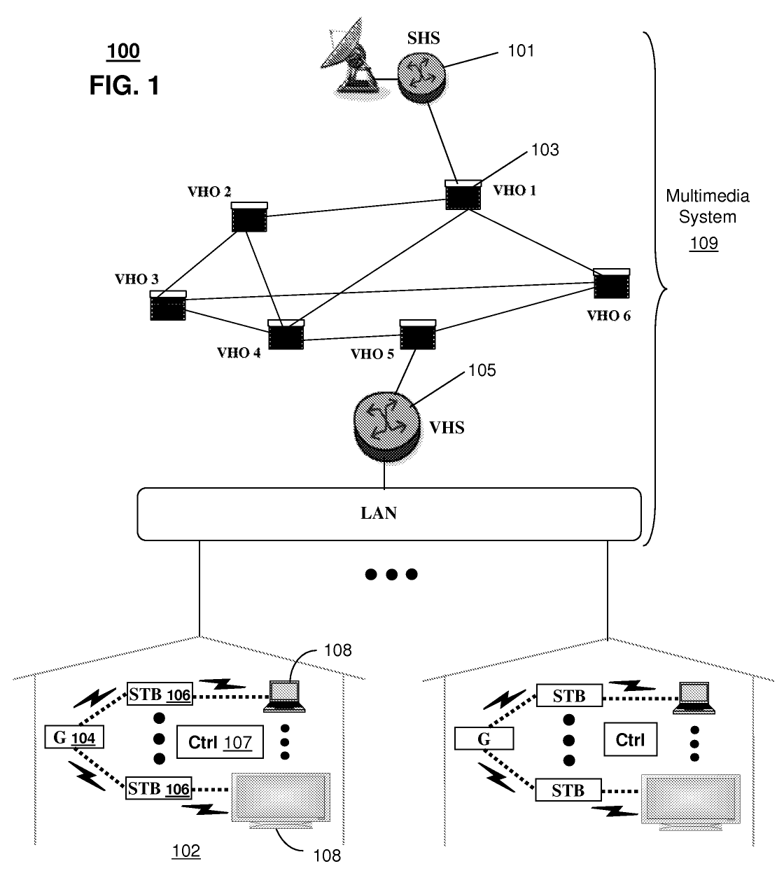

FIG. 1 depicts an exemplary embodiment of a communication system 100. The communication system 100 can comprise a multimedia system 109 serving a plurality of residences and/or commercial enterprises. In the present illustration the multimedia system 109 can represent an IPTV system. A typical IPTV backbone can comprise a number of IPTV subsystems. For example, there can be at least one super head office server (SHS) 101 which receives national media programs from satellite and/or media servers from service providers of multimedia broadcast channels. The SHS server 101 forwards IP packets associated with the media content to video head servers (VHS) 105 via a network of video head offices (VHO) 103 according to a common multicast communication method.

The VHS 105 then distributes multimedia broadcast programs to commercial and/or residential buildings 102 housing a gateway 104 (e.g., a residential gateway or RG) that distributes broadcast signals to presentation devices 106 such as Set-Top Boxes (STBs) which in turn present broadcast selections to media devices 108 (e.g. computers, television sets, high-fidelity audio systems, etc) managed in some instances by a media controller 107 (e.g., an infrared or RF remote control). For convenience, a presentation device 106 will be referred to herein as an STB 106.

Unicast traffic can also be exchanged between the STBs 106 and the subsystems of the multimedia system 109 for services such as video-on-demand (VoD). Although not shown, the aforementioned multimedia system 109 can be combined or replaced with other broadcast distributions systems such as those deployed by satellite and cable TV providers. Media programs presented by the STBs 106 can include video content (e.g., movies, personal video, personal album of still pictures, personal movies, etc.), audio content (e.g., music content such as MP3 files), or combinations thereof.

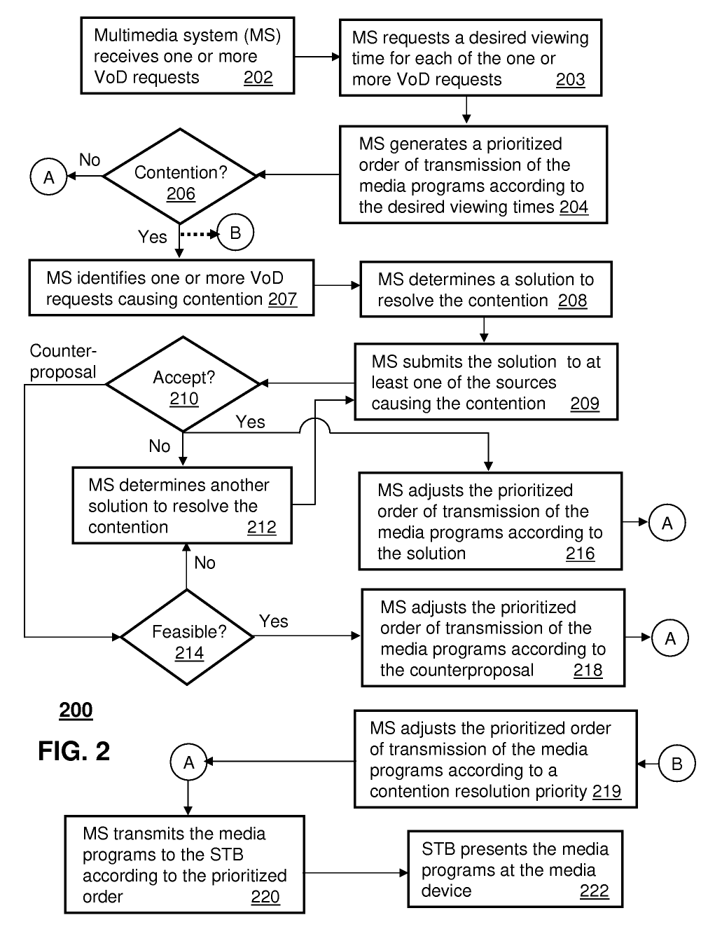

FIG. 2 depicts an exemplary method 200 operating in portions of the communication system 100. One or more of the aforementioned IPTV subsystems of the multimedia system 109 as shown in FIG. 1 and/or other computing devices coupled thereto can be programmed to perform the tasks of method 200. For illustration purposes only, method 200 will refer to the multimedia system (MS) 109 collectively as performing the tasks disclosed herein.

With this in mind, method 200 begins with step 202 where the MS 109 receives a VoD request corresponding to a selection made by an end user with a media controller 107 located in building 102, or a roaming portable communication device such as a cell phone, or a laptop computer by way of a cellular network or WiFi access point connected directly or indirectly to the STB 106 by way of the MS while a party is in transit (e.g., riding on a train on the way to the office or home). In step 203, the MS 109 requests a desired viewing time for each of one or more VoD requests received from one or more end users. This step can represent a prompt submitted to one or more devices from which the VoD requests originated. In the case of the media controller 107, the prompt can be displayed at an LCD integrated therein, or on the media device 108 coupled to the STB 106. In the case of a portable communication device, the prompt can be presented as a graphical user interface (GUI) such as a pop-up screen that presents an inquiry such as, “When would you like to view the movie you have selected?.”

Once each the end users requesting a VoD selection enters a desired viewing time (e.g., 8 pm), the MS 109 proceeds to step 204 where it generates a prioritized order of transmission for each of the media programs according to their respective viewing times. For example, a media program scheduled for an 8 pm viewing would be downloaded before the media program scheduled for an 8:30 pm viewing. In step 206, the MS 109 can determine whether the media programs can be viewed at their respective desired viewing times according to one or more conditions.

These conditions can include without limitation a transmission time calculated by the MS 109 to deliver each of the media programs to the STB 106, a program duration of each of the media programs which can be determined from a header in the media programs or a media program catalog, an expected utilization of subsystems of the MS 109 at times when the media programs are expected to be transmitted to the STB 106, and an expected utilization of the STB 106 at times when the media programs are expected to be transmitted, and so on. From these conditions and other determination techniques not described herein but suitable for the methods described in the present disclosure, the MS 109 can determine whether a contention exists between two or more of the media programs requested.

Suppose, for example, that a first media program request has a program duration of 1 hour and 15 minutes with a desired viewing time of 8:15 pm, a second media program request has a program duration of 45 minutes with a desired viewing time of 8 pm, and a third media program request has a program duration of 1 hour 30 minutes and a desire viewing time of 9:30 pm. Assume also that the time determined by the MS 109 to transmit to the STB 106 the first media program is 55 minutes, while the second and third media programs have transmission times of 25 minutes and 1 hour respectively. As noted earlier these transmission times can be based on the length of the media program (e.g., x Mbytes of data for high definition TV, y Mbytes for standard TV, etc.), the utilization of the MS 109 (e.g., expected network traffic conditions at an expected delivery time), and/or the utilization of the STB 106 during the expected deliver time (e.g., on standby, under heavy usage based on prior historical measurements taken by the MS, etc.).

Further assume that the request for the first media program is supplied to the MS 109 at 6:45 pm, while the requests for the second and third media programs arrive at 6:55 pm and 6:50 pm respectively. Under these circumstances, the MS 109 will initially establish in step 204 a priority order of transmission in which the second media program is to be transmitted first, the first media program is next, and the third media program is last even though the MS 109 received the requests in a different order. As noted earlier, the MS 109 in step 204 relies on the desired viewing times to determine a priority order of transmission.

Next assume the MS 109 chooses to start delivery at 7 pm. At this time, the second media program can be delivered to the STB 108 at approximately 7:25 pm, which satisfies its desired viewing time with 35 minutes to spare. Suppose that immediately thereafter the MS 109 begins to deliver the first and third media programs. Starting at 7:25 pm the MS 109 can expect to deliver the first media program to the STB 106 at 8:20 pm (5 minutes over its desired viewing time), and the third media program at 9:20 pm (10 minutes before its desired viewing time).

Note that a viewing of the second media program begins at 8 pm which could affect the rate that the STB 106 can receive the first and third media programs if only one STB is available in the residence 102. Note also, that traffic conditions experienced by the MS 109 and/or the gateway 104 can also affect the rate of delivery to the STB 106. Assume, however, that the MS 109 took this into consideration in the transmission time previously calculated.

Note also that the program duration of the second media program is 45 minutes, which results in a viewing completion time of 8:45 pm (30 minutes over the 8:15 pm desired viewing time of the first media program). If the first media program could start on time its completion time would be 9:30 pm which satisfies the viewing time of the third media program. Using the foregoing techniques, the MS 109 can detect in step 207 that contention exists between the first and second media program requests.

To arbitrate a contention issue such as this, the MS 109 proceeds to step 208 to determine a resolution. In the present illustration, the MS 109 can determine that an earlier viewing time for the second media program (e.g., 7:30 pm) would resolve the contention between the first and second media program requests while maintaining compliance with the viewing time of the third media program. With such a solution at hand, the MS 109 can proceed to step 209 where it submits this solution to the requesting party of the second media program by way of the media device 108, media controller 107 (with LCD), or portable communication device as the case may be. The MS 109 does not supply the proposed solution to the requesting party of the first media program since the solution does not require a change to the viewing time previously submitted to the MS.

In step 210, the MS 109 waits for a response from the requesting party of the second media program. If the MS 109 receives in this step a message from the requesting party's portable communication device (or media controller 107) indicating that the proposed time has been accepted, the MS proceeds to step 216 where it adjusts the prioritized order of transmission of the media programs determined in step 204 according to said solution. Since there was only a change to the viewing time of the second media program, there is no actual change to the order of transmission. However, had the solution involved a different proposed order of transmission, this step would have performed said adjustment.

From step 216, the MS 109 proceeds to step 220 where it transmits the first, second and third media programs according to the updated order of priority. In step 222, the STB 106 presents the first through third media programs at their desired viewing times. In step 222 the STB 106 can be programmed as a supplemental embodiment to allow viewing of the media programs only at their respective desired viewing times to avoid one party causing a contention with another.

Referring back to step 210, if the solution proposed by step 208 (i.e., a 7:30 pm viewing) is not accepted by the requesting party of the second media program, the MS 109 proceeds to step 212 where it determines another solution, and repeats steps 209-210 as previously described. In step 210, the MS 109 can also entertain a counterproposal from the requesting party. In this case, the MS 109 can proceed to step 214 where it determines if the counterproposal is feasible. For example, the requesting party might request a 7:45 pm viewing rather than a 7:30 pm viewing. Such a counterproposal would not be feasible since 7:45 would lead to a viewing completion time of 8:30 pm, 15 minutes over the desired viewing time of the first media program. If the counterproposal is not feasible, the MS 109 proceeds to step 212 where it determines yet another solution, but this time with feedback from one of the parties. If, however, the counterproposal is feasible, the MS 109 proceeds to step 218 where it adjusts the priority order of transmission according to the counterproposal, and repeats steps 220-222 as previously described.

Referring back to step 206, if there is no contention between the viewing times given for the three VoD requests, the MS 109 proceeds to steps 220-222 as previously described using the prioritized order of transmission determined in step 204. In an alternative embodiment, the MS 109 can be pre-provisioned with a contention resolution priority assigned to each end user of the STB 109. These priority settings can be established by an administrator of the household entertainment system (e.g., a parent) by accessing a website, speaking with an operator of the MS 109, or by other suitable means to inform the MS. The contention resolution priorities can provide the MS 109 a priority order for resolving contentions (e.g., parents have a higher priority than eldest child; eldest child has a higher priority than the next oldest child, and so on). With this priority setting, the MS 109 can proceed to step 219 and adjust the prioritized order of transmission determined in step 204. And as before proceed to steps 220-222 as previously described.

Upon reviewing the foregoing embodiments, it would be evident to an artisan with ordinary skill in the art that the present disclosure can be modified, reduced, or enhanced without departing from the scope and spirit of the claims described below. For example, other arbitration techniques suitable to the tasks described by method 200 can be applied to the present disclosure. A portion or all of method 200 can operate in the STB 106 rather in its entirety at the MS 109.

Additionally, the MS 109 can be programmed to determine the transmission time and prioritized order of transmission of the media programs taking into account time savings afforded with progressive transmission (or download) and playback techniques. That is, rather than waiting until a media program has been completely transmitted to the STB 106, presentation can commence at the media device 108 while the media program is being transmitted. This technique allows the MS 109 to consider the viewing period of the media program as part of its download time.

For example, suppose a desired view time is 8 pm for one media program and 8:30 pm for a second media program. The half hour between 8 and 8:30 pm can be considered by the MS 109 as part of the download time for both the first and second media programs. With this additional time savings, the MS 109 can determine an appropriate order and schedule of transmissions that can effectively satisfy the requesting parties' their desired viewing times. If a contention arises, the progressive download technique can at least mitigate the extent of adjustment needed to resolve the contention. Note also, that a progressive download can be applied on some and not necessarily all of the media programs requested at the onset of the requests, or as part of a technique to arbitrate contention between parties.

These are but a few examples of modifications that can be applied to the present disclosure without departing from the scope of the claims. Accordingly, the reader is directed to the claims section for a fuller understanding of the breadth and scope of the present disclosure.

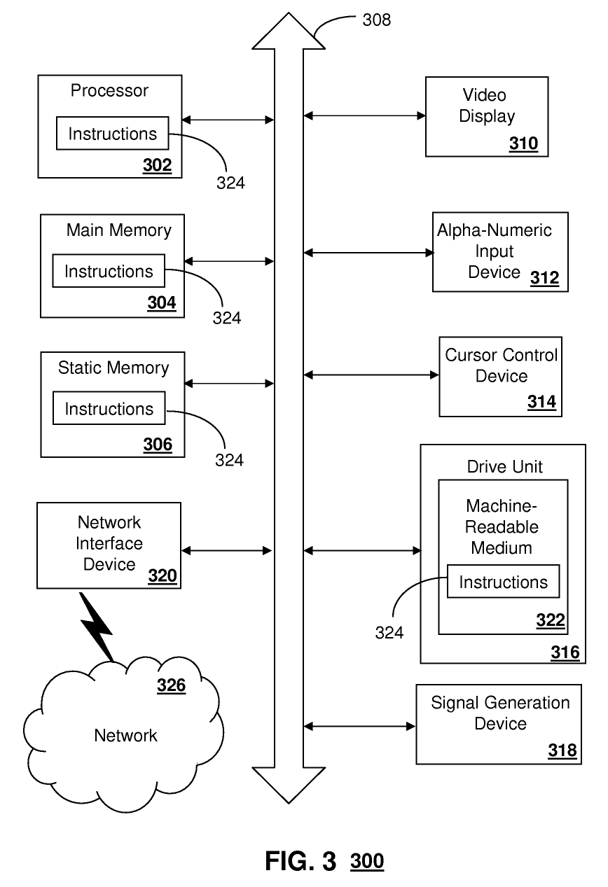

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A multimedia system, comprising a controller element that:
receives a transmission request for each of a plurality of media programs;
receives a desired viewing time for each of the plurality of media programs;
prioritizes an order for transmitting the plurality of media programs according to their respective desired viewing times; and
transmits to a presentation device the plurality of media programs according to the prioritized order of transmission for presenting said media programs at a media device coupled to the presentation device.

2. The multimedia system of claim 1, wherein the presentation device corresponds to a set-top box, and wherein the controller element receives the transmission requests and the desired viewing times for the media programs from at least one among a portable communication device, the media controller, the STB, and the media controller by way of the STB, each communicatively coupled to the multimedia system.

3. The multimedia system of claim 1, wherein the controller element determines whether the media programs can be viewed at their respective desired viewing times according to one or more conditions.

4. The multimedia system of claim 3, wherein the one or more conditions comprise at least one among a transmission time calculated by the controller element to deliver each of the media programs to the presentation device, a program duration of each of the media programs, an expected utilization of a communication network at times when the media programs are expected to be transmitted to the presentation device, and an expected utilization of the presentation device at times when the media programs are expected to be transmitted thereto.

5. The multimedia system of claim 1, wherein the controller element detects a contention in transmitting at least two of the media programs to the presentation device for presentation at their respective desired viewing times.

6. The multimedia system of claim 5, wherein the controller element arbitrates between sources requesting the media programs that are causing the contention.

7. The multimedia system of claim 6, wherein the controller element:
identifies two or more media programs requested that cannot be delivered to the presentation device in satisfaction of their respective desired viewing times, thereby giving rise to the contention;
determines a solution to resolve the contention; and
submits to at least one of the sources the solution.

8. The multimedia system of claim 7, wherein the controller element:
receives an acceptance of the solution from at least one of said sources; and
adjusts the prioritized order of transmission of the media programs according to said solution; and
transmits the media programs to the presentation device according to said adjusted prioritized order of transmission.

9. The multimedia system of claim 7, wherein the controller element receives a counterproposal to the solution from at least one of said sources.

10. The multimedia system of claim 9, wherein the controller element adjusts the prioritized order of transmission of the media programs according to the counterproposal in response to determining that the counterproposal resolves the contention.

11. The multimedia system of claim 9, wherein the controller element:
determines that said counterproposal does not resolve the contention; and
determines a second solution to resolve the contention; and
submits to at least one of the sources said second solution.

12. The multimedia system of claim 11, wherein the controller element repeats the foregoing steps until the contention is resolved.

13. The multimedia system of claim 6, wherein the controller element adjusts the prioritized order of transmission of the media programs according to a contention resolution priority assigned to each of said sources.

14. The multimedia system of claim 1, wherein the presentation device receives and presents at least one of the requested media programs during a progressive transmission.

15. The multimedia system of claim 6, wherein said sources comprise at least one among a portable communication device, and a media controller, and wherein said presentation device comprises an STB, wherein said STB presents the media program at a display unit, and wherein the media program comprises one among video content, and an audio content.

16. The multimedia system of claim 1, wherein the multimedia system comprises an Internet Protocol Television (IPTV) subsystem comprising at least one among a super head office server, a video head server, and a video head office server.

17. A computer-readable storage medium in a presentation device, comprising computer instructions for receiving a media program from a multimedia system according to a desired viewing time.

18. The storage medium of claim 17, comprising computer instructions for receiving in a prioritized order the media program and one or more other media programs according to their respective desired viewing times.

19. A method, comprising prioritizing an order of transmission of a plurality of media programs to satisfy in part a plurality of desired view times for said media programs.

20. The method of claim 19, comprising:
detecting a contention for presenting at least two of the plurality of media programs at their respective viewing times; and
arbitrating with one or more sources requesting the at least two media programs to resolve said contention.
